(19) United States
(12) Patent Application Publication
(10) Pub. No.: US 2013/0321760 A1
(43) Pub. Date: Dec. 5, 2013

(54) Cushion Covering For Eyeglass Nose Pads

(71) Applicant: Bruce David Silverman, Minneapolis, MN (US)

(72) Inventor: Bruce David Silverman, Minneapolis, MN (US)

(21) Appl. No.: 13/486,442

(22) Filed: Jun. 1, 2012

(51) Int. Cl. G02C 5/12; G02C 13/00

(52) U.S. Cl. 351/139; 351/178

(57) ABSTRACT

Removable and replaceable cushion coverings for eyeglass nose pads are disclosed that are constructed of a cushion substrate at least partially enclosed in at least a first layer of cloth material having an elasticized opening that slips over the nose pad and between the nose pad and the eye glass guard arm such that the elasticized opening contracts in a perimeter around the attachment point that connects the nose pad to the guard arm of the eyeglass frame. The cushion coverings can be manufactured in various sizes to accommodate various nose pad shapes and sizes.

### FIELD OF THE INVENTION

The present invention relates generally to eyeglasses and more particularly to cushion coverings for eyeglass nose pads and their method of attachment.

### BACKGROUND OF THE INVENTION

One of the most common problems concerning eyewear, and more specifically, prescription eyeglasses that are typically worn for extended periods of time, is the pressure that the nose pads exert on the sides of the nasal bridge. Over time, the pressure can subject the eyeglass wearer to discomfort as well as unsightly indentations on the sides of the nasal bridge.

A number of solutions have been proposed to ameliorate the problem by providing a cover or attachment for the eyeglass nose pad that offers some manner of cushion relief. U.S. Pat. No. 4,070,104 to Rice discloses a padded base with one side of said base having a pressure sensitive adhesive coating thereon for securing said base to the nose piece and a plurality of spaced parallel tubing mounted on the opposite side of said base, said tubing being compressed against the sides of the nose for providing an air cushion when the eyeglasses are in use. U.S. Pat. No. 4,964,716 to Combs discloses a nose pad cover for a nose pad on a pair of eyeglasses comprising first and second members having releasably engageable portions formed of interlocking hook and pile and means for fixedly mounting one of the first and second members on the nose pad of a pair of eyeglasses with the releasably engageable portion thereof facing away from the nose pad of the pair of eyeglasses. U.S. Pat. No. 6,065,834 to Willhite discloses a pair of eyeglass nose piece wraps custom cut from a thin elastic material wherein said nose piece wraps are defined by an oval body portion having wing portions and tab portions. Additionally, there are generically produced foam rubber nose pad attachments that utilize a basic self adhesive siding for attachment to eyeglass nose pads.

While the aforementioned examples of prior art might provide some amount of relief of pressure on the nasal bridge, they share the same shortcomings in terms of staying affixed to the eyeglass nose pad. Adhesive based attachments tend to lose their tack over time and may eventually become dislodged from the eyeglass nose pad, while, similarly, those employing self-clinging tabs that wrap around the nose pad also may come loose over time. Moreover, cushion coverings for eyeglass nose pads that employ an adhesive attachment method often leave undesirable sticky residues on the eyeglass nose pads. Further still, foam rubber substrates used for cushioning that come in direct contact with the nasal bridge can accumulate moisture at the contact point with the skin, thereby causing slippage and/or irritation.

Therefore, there is a need for replaceable cushion coverings for eyeglass nose pads that provide a more comfortable, clean and reliable alternative to the prior art.

### BRIEF SUMMARY OF THE INVENTION

The present invention introduces an improved cushion covering for eyeglass nose pads that alleviates pressure on the sides of the nasal bridge while also allowing for secure, clean, comfortable and reliable attachment and easy detachment and replacement.

Embodiments of the cushion covering constructed in accordance with the principles of the present invention employ a substrate composed of a natural or synthetic cushion material having a resilient characteristic that is at least partially enclosed in at least a first layer of natural or synthetic cloth material having an elasticized opening orientated on the back side of the cushion covering that can be stretched over the surface of a given nose pad and securely enclose around the surface of the nose pad such that the elasticized opening contracts in a perimeter around the attachment point that connects the nose pad to the guard arm of the eyeglass frame.

In a first exemplary embodiment of the invention, the cushion substrate material is enclosed in a first layer of cloth material having an elasticized opening orientated on the back side of the cushion covering that is sized to securely enclose around the surface of the nose pad such that the elasticized opening contracts in a perimeter around the attachment point that connects the nose pad to the guard arm of the eyeglass frame.

In a second exemplary embodiment of the invention, the cushion substrate is additionally enclosed, either partially or fully, in a second layer of cloth material which in turn is enclosed by the first layer of cloth material having the elasticized opening.

In a third exemplary embodiment of the invention, the cushion substrate is partially or fully enclosed by a second layer of cloth material and the first layer of cloth material having the elasticized opening can be sewn or otherwise attached to the second layer of cloth material.

Therefore, according to one aspect of the present invention, there is provided a cushion covering for eyeglass nose pads, comprising: a substrate formed of a cushion material having a resilient characteristic; and at least a first layer of cloth material at least partially enclosing said substrate, the first layer of cloth material having an opening with an elasticized perimeter, wherein: the perimeter of the elasticized opening in a relaxed state is smaller than the surface perimeter of a given eyeglass nose pad; the elasticized opening provides sufficient elasticity to encompass the surface of the nose pad when stretched over the perimeter of the nose pad; and the elasticized opening provides sufficient elastic resistance upon release to securely enclose around the surface of the nose pad such that the elasticized opening contracts in a perimeter around the attachment point that connects the nose pad to the guard arm of the eyeglass frame.

### BRIEF DESCRIPTION OF THE DRAWINGS

The features and advantages that characterize the various embodiments of the invention are further defined in the following drawings and descriptive matter.

FIG. 1 illustrates a partial perspective view of an eyeglass frame that includes a nose pad, guard arm, eyewire and bridge.

FIG. 2 illustrates a front view of a cushion covering for an eyeglass nose pad according to an embodiment of the present invention enclosed in at least a first layer of cloth material having an elasticized opening orientated on the back side of the covering.

FIG. 3 illustrates a side view of a cushion covering for an eyeglass nose pad according to an embodiment of the present invention enclosed in at least a first layer of cloth material having an elasticized opening orientated on the back side of the covering.

FIG. 4 illustrates a back view of a cushion covering for an eyeglass nose pad according to an embodiment of the present invention enclosed in at least a first layer of cloth material having an elasticized opening orientated on the back side of the covering.

FIG. 5 illustrates a back view of a cushion covering for an eyeglass nose pad according to an embodiment of the present invention enclosed in at least a first layer of cloth material having an elasticized opening orientated on the back side of the covering.

FIG. 6 illustrates a front view of a cushion covering for an eyeglass nose pad according to an embodiment of the present invention revealing the cushion substrate that is enclosed in at least a first layer of cloth material having an elasticized opening orientated on the back side of the covering.

FIG. 7 illustrates a cross sectional view of a cushion covering for an eyeglass nose pad according to an embodiment of the present invention showing the cushion substrate enclosed in a first layer of cloth material having an elasticized opening orientated on the back side of the covering.

FIG. 8 illustrates a cross sectional view of a cushion covering for an eyeglass nose pad according to an embodiment of the present invention showing the cushion substrate enclosed in a second layer of cloth material which in turn is enclosed in a first layer of cloth material having an elasticized opening orientated on the back side of the covering.

FIG. 9 illustrates a cross sectional view of a cushion covering for an eyeglass nose pad according to an embodiment of the present invention showing the cushion substrate enclosed in a second layer of cloth material which in turn is secured to a first layer of cloth material with an elasticized opening orientated on the back side of the covering.

FIG. 10 illustrates a perspective view of a cushion covering for an eyeglass nose pad according to an embodiment of the present invention partially applied to an eyeglass nose pad.

FIG. 11 illustrates a perspective view of a cushion covering for an eyeglass nose pad according to an embodiment of the present invention partially applied to an eyeglass nose pad.

FIG. 12 illustrates a perspective view of a cushion covering for an eyeglass nose pad according to an embodiment of the present invention fully applied to an eyeglass nose pad.

### DETAILED DESCRIPTION OF THE INVENTION

Reference will now be made in detail to exemplary aspects of the present invention which are illustrated in the accompanying drawings. Wherever possible, the same reference numbers are used throughout the drawings to refer to the same parts.

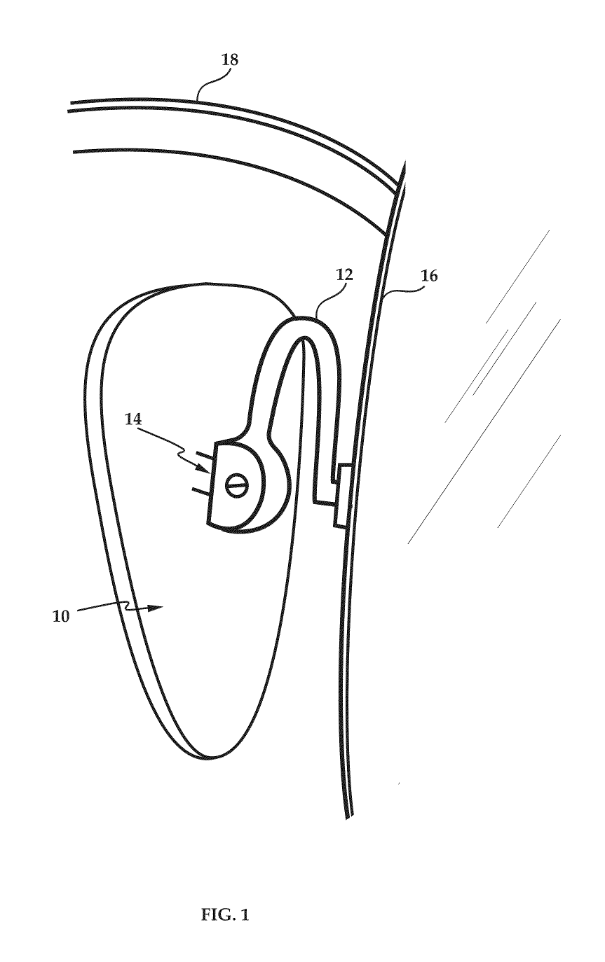

FIG. 1 is an illustration that depicts a partial perspective view of the portion of a common eyeglass frame assembly that includes an eyeglass nose pad 10 attached to a guard arm 12 at an attachment point 14. The guard arm 12 is in turn affixed to an eyewire 16 which is affixed to a bridge 18, the bridge being affixed to an opposing eyewire. The nose pad 10 is generally defined as a small pad constructed of silicone, vinyl, PVC or other material designed to lift and hold the eyeglass frame up off the nose and away from the face. The guard arm 12 is generally defined as a small wire arm affixed to the eyewire 16 at one end and attaches to the nose pad 10 at the other end. The attachment point 14 is defined as the area of the nose pad 10 at which point the nose pad attaches to the guard arm 12 by means of a guard arm mount. The mount portion of a guard arm 12 can be one of many mount types including screw-on and snap-in, but is most often a screw-on mount. The eyewire 16 is generally defined as the portion of the eyeglass frame that surrounds the lens and holds the lens in place. The bridge 18 is generally defined as the portion of the frame that connects the two eyewires of an eyeglass frame.

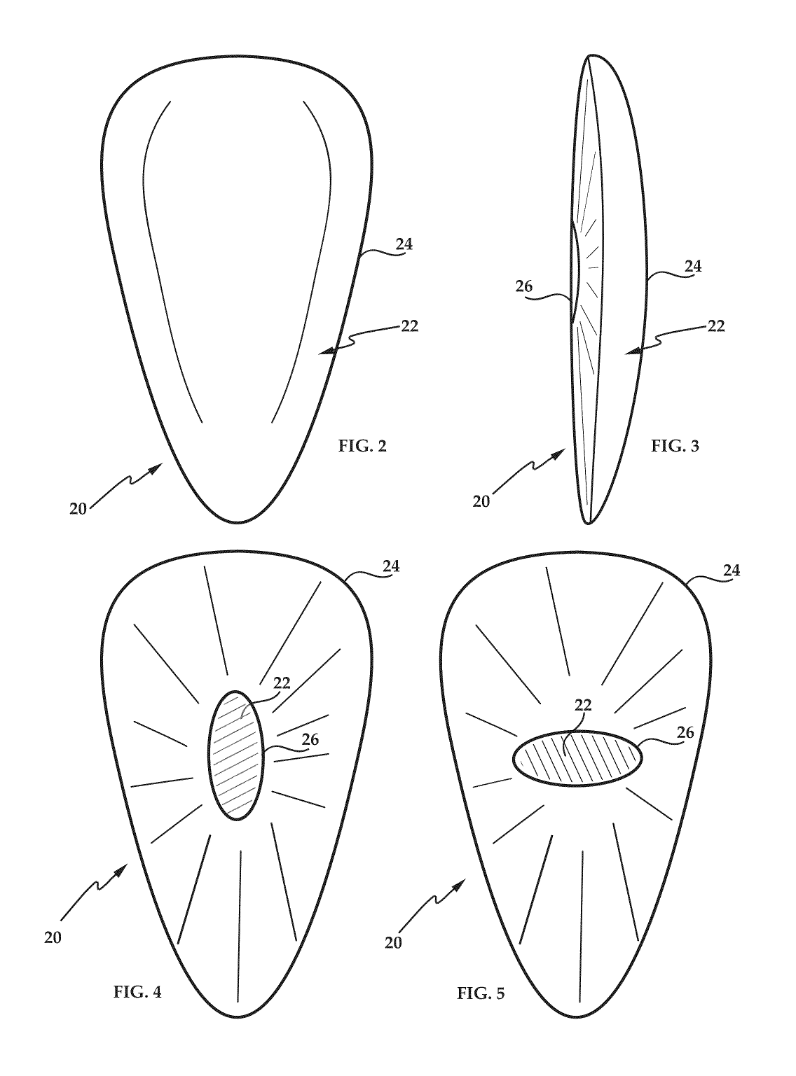

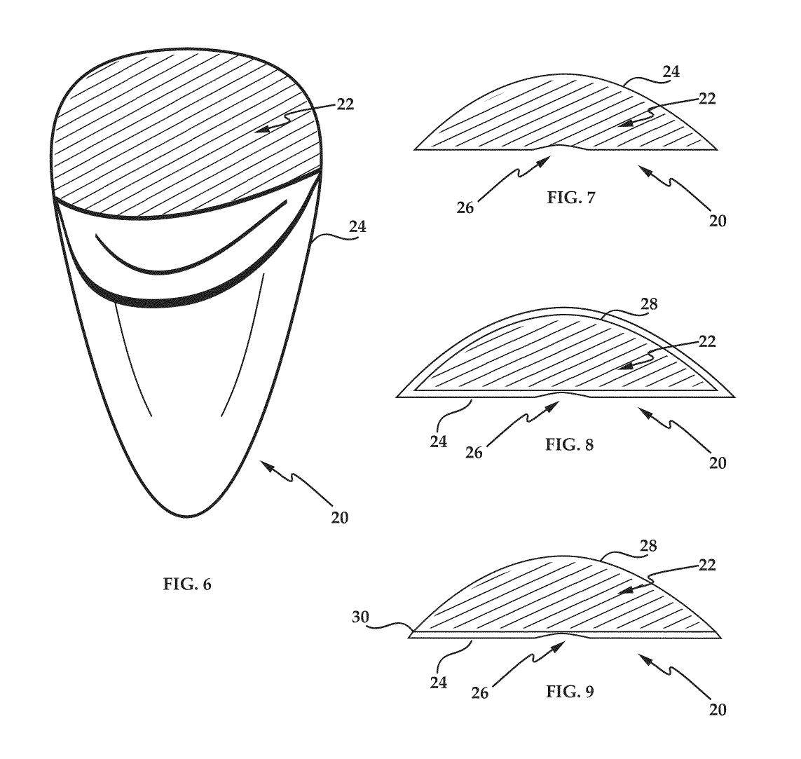

FIG. 2, FIG. 3, FIG. 4 and FIG. 5 are illustrations that depict respectively the front view, side view and two back views of a cushion covering for an eyeglass nose pad according to an embodiment of the present invention 20 in which the cushion covering is comprised of a substrate composed of a natural or synthetic cushion material having a resilient characteristic 22 that is at least partially enclosed in a natural or synthetic cloth material 24 having an elasticized opening 26 orientated on the back side of the cushion covering. As illustrated in FIG. 4 and FIG. 5, the elasticized opening 26 of the cloth material 24 that encloses the cushion substrate 22, may conform to any particular geometric dimensions and may subscribe to any angular orientation to best accommodate the dimensions of a given nose pad. The elasticized opening 26 may also utilize any number of elastic materials including, but not limited to, rubber or polymer strings, either enclosed or otherwise attached along the perimeter of the opening of the cloth material.

FIG. 6 illustrates a front view of a cushion covering for an eyeglass nose pad according to an embodiment of the present invention 20 that reveals the cushion substrate 22 beneath a first layer of cloth material 24.

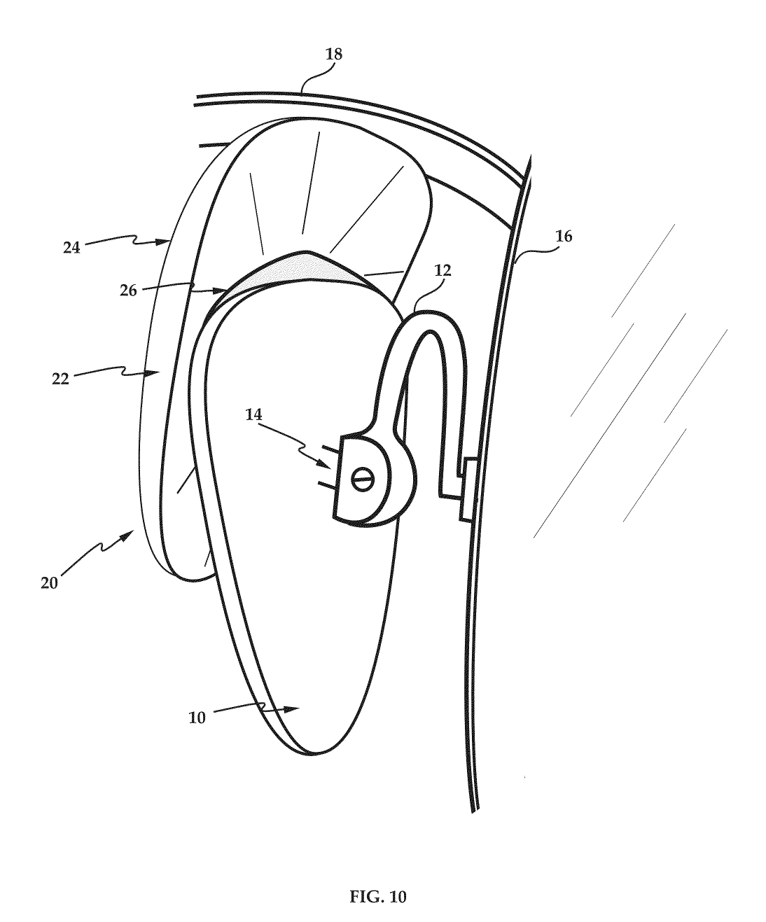

FIG. 7 illustrates a cross sectional view of a cushion covering for an eyeglass nose pad according to an embodiment of the present invention 20 in which the cushion substrate 22 is enclosed in a first layer of cloth material 24 having an elasticized opening 26 orientated on the back side of the cushion covering.

FIG. 8 illustrates a cross sectional view of a cushion covering for an eyeglass nose pad according to an embodiment of the present invention 20 in which the cushion substrate 22 is partially or fully enclosed in a second layer of cloth material 28 which in turn is enclosed by the first layer of cloth material 24 having an elasticized opening 26 orientated on the back side of the cushion covering.

FIG. 9 illustrates a cross sectional view of a cushion covering for an eyeglass nose pad according to an embodiment of the present invention 20 in which the first layer of cloth material 24 with an elasticized opening 26 orientated on the back side of the cushion covering is sewn, glued or otherwise fastened to the second layer of cloth material 28 along a line of given attachment points 30.

FIG. 10 illustrates a perspective view of a cushion covering for an eyeglass nose pad according to an embodiment of the present invention 20 that is partially applied to an eyeglass nose pad 10. As depicted in the illustration, the elasticized opening 26 of the first layer of cloth material 24 that encloses the cushion substrate 22 provides sufficient elasticity to stretch over the surface of the nose pad 10 which is connected to the guard arm 12 at attachment point 14, the guard arm 12 being affixed to an eyewire 16 enclosing an eyeglass lens, and the eyewire 16 being affixed to a bridge 18 connecting the eyewire to the opposing eyewire of the eyeglass frame.

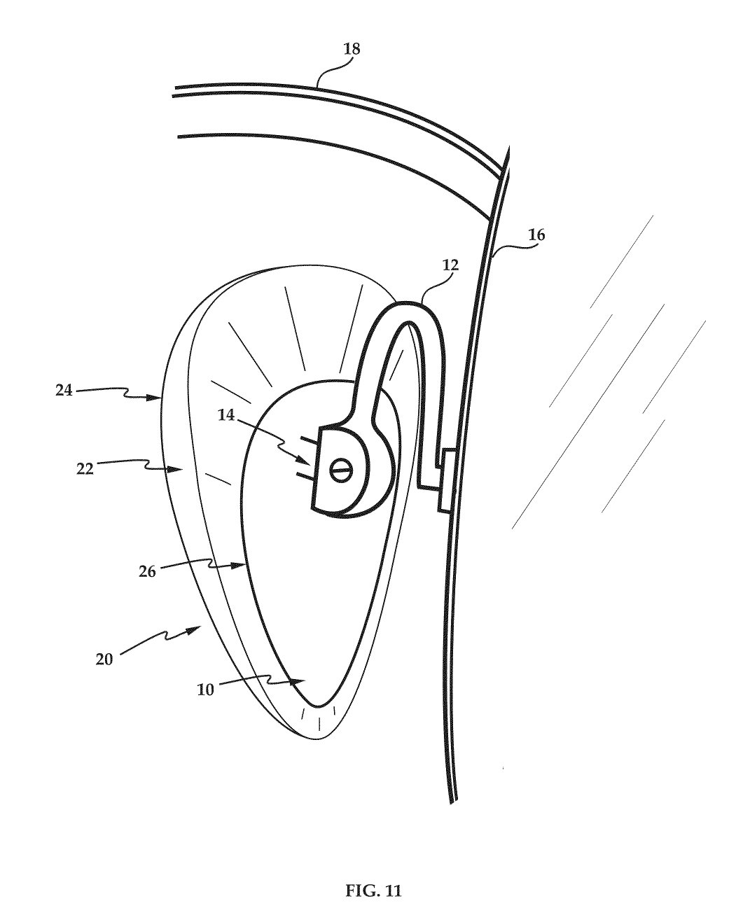

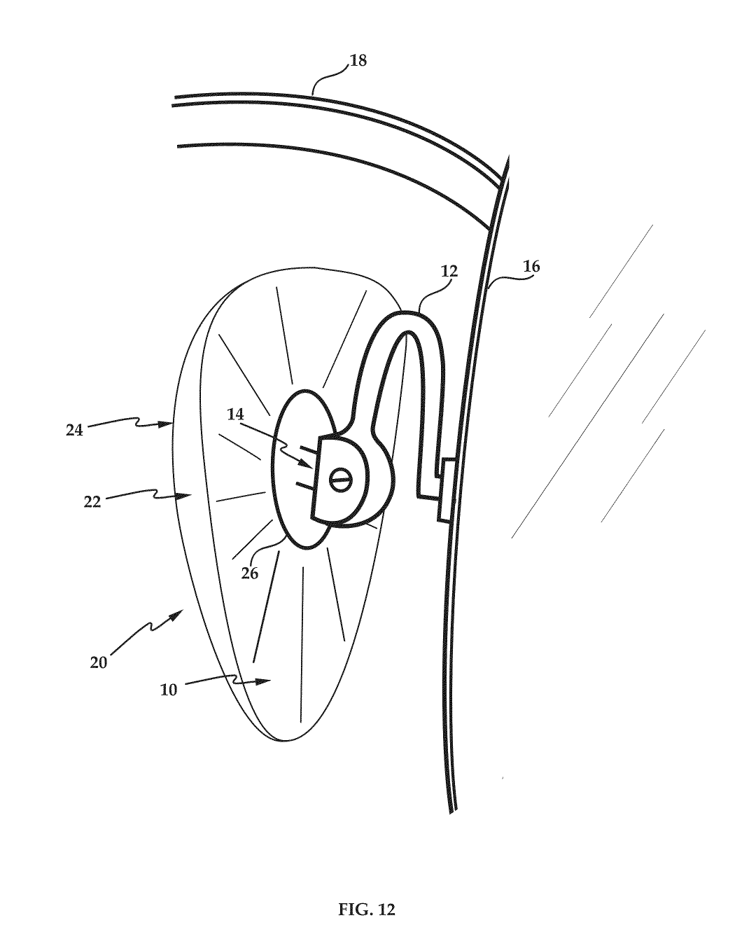

FIG. 11 illustrates a perspective view of a cushion covering for an eyeglass nose pad according to an embodiment of the present invention 20 that is nearly completely applied to an eyeglass nose pad 10. As depicted in the illustration, the first layer of cloth material 24 at its elasticized opening 26 is appreciably separable from the cushion substrate 22 to encompass the nose pad 10 such that the first layer of cloth material 24 slips between the nose pad 10 and the guard arm 12.

FIG. 12 illustrates a perspective view of a cushion covering for an eyeglass nose pad according to an embodiment of the present invention 20 that is fully applied to an eyeglass nose pad 10. As depicted in the illustration, the elasticized opening 26 of the first layer of cloth material 24 that encloses the cushion substrate 22 provides sufficient elastic resistance once applied to the nose pad to contract around the perimeter of the attachment point 14 connecting the nose pad 10 to the guard arm 12, which in turn is affixed to the eyewire 16 of the eyeglass frame.

It will be appreciated that the cushion covering of the present invention can be constructed in various shapes and sizes to accommodate the dimensions of the vast majority of removable and replaceable eye glass nose pads. For example, the cushion covering can be symmetrically or asymmetrically oval shaped, symmetrically or asymmetrical teardrop shaped, “D” shaped or otherwise generally oval in shape. Similarly, the cushion covering can be round in shape, otherwise referred to as button shaped. Furthermore, the cushion covering can be constructed in accordance with the aforementioned shapes in various sizes, for example, small, medium and large, to accommodate the vast majority of nose pads of different dimensions. Further still, in the case of “D” shaped nose pads, where the left nose pad is the mirror image shape of the right nose pad, and vice versa, the cushion covering of the present invention can be constructed specifically to accommodate left and right nose pads.

It will also be appreciated that the cushion covering of the present invention, and, in particularity, the first layer of cloth material, can be printed in different colors and/or designs to complement the color, design or general fashion of any given eye glass frame.

Finally, it will be appreciated that while the embodiments shown and described herein are sufficiently illustrative of the principles, benefits and versatility of the present invention, various modifications may be implemented by those skilled in the art without departing from the scope and spirit of the invention.

What is claimed is:

1. A cushion covering for eyeglass nose pads, comprising:
a substrate formed of a cushion material having a resilient characteristic; and
at least a first layer of cloth material at least partially enclosing said substrate, the first layer of cloth material having an opening with an elasticized perimeter, wherein:
the perimeter of the elasticized opening in a relaxed state is smaller than the surface perimeter of a given eyeglass nose pad;
the elasticized opening provides sufficient elasticity to encompass the surface of the nose pad when stretched over the perimeter of the nose pad; and
the elasticized opening provides sufficient elastic resistance upon release to securely enclose around the surface of the nose pad such that the elasticized opening contracts in a perimeter around the attachment point that connects the nose pad to the guard arm of the eyeglass frame.

2. The cushion covering of claim 1, wherein the cushion substrate is composed at least in part of a natural material.

3. The cushion covering of claim 2, wherein the natural material is cotton.

4. The cushion covering of claim 2, wherein the natural material is latex.

5. The cushion covering of claim 1, wherein the cushion substrate is composed at least in part of a synthetic material.

6. The cushion covering of claim 5, wherein the synthetic material is polymer-based.

7. The cushion covering of claim 1, wherein the resilient cushion substrate is at least partially comprised of a loose, filling material.

8. The cushion covering of claim 1, wherein the material comprising the resilient cushion substrate is one piece.

9. The cushion covering of claim 1, wherein the first layer of cloth material is composed at least in part of a natural material.

10. The cushion covering of claim 9, wherein the natural material is cotton.

11. The cushion covering of claim 1, wherein the first layer of cloth material is composed at least in part of a synthetic material.

12. The cushion covering of claim 11, wherein the synthetic material is polymer-based.

13. The cushion covering of claim 1, further comprising a second layer of cloth material at least partially enclosing the cushion substrate, wherein said second layer of cloth material is situated between the cushion substrate and the first layer of cloth material.

14. The cushion covering of claim 13, wherein the second layer of cloth material is composed at least in part of a natural material.

15. The cushion covering of claim 14, wherein the natural material is cotton.

16. The cushion covering of claim 13, wherein the second layer of cloth material is composed at least in part of a synthetic material.

17. The cushion covering of claim 16, wherein the synthetic material is polymer-based.

18. The cushion covering of claim 13, wherein the first layer of cloth material at least partially encloses the second layer of cloth material.

19. The cushion covering of claim 13, wherein the first layer of cloth material is at least partially affixed to the second layer of cloth material.

20. A method of applying a cushion covering to eyeglass nose pads, comprising:
a) providing a substrate composed of a cushion material having a resilient characteristic at least partially enclosed by at least a first layer of cloth material having an opening with an elasticized perimeter, the elasticized opening in a relaxed state being smaller than the surface area of a given eyeglass nose pad and providing sufficient elasticity to encompass the surface area of the given nose pad when stretched over the surface of the nose pad and sufficient elastic resistance to securely contract around the surface of the nose when the stretching action is discontinued; and
b) stretching the combined cushion substrate and at least first layer of cloth material over the given eyeglass nose pad by means of the elasticized opening of the first layer of cloth material such that the elasticized opening slips between the nose pad and guard arm connecting the nose pad to the eyewire of the eye glass frame and encompasses the surface area of the nose pad such that the elasticized opening contracts in a perimeter around the attachment point that connects the nose pad to the guard arm of the eyeglass frame.
